(19) United States
(12) Patent Application Publication
(10) Pub. No.: US 2004/0255628 A1
(43) Pub. Date: Dec. 23, 2004

(54) Door lock system and method

(76) Inventor: Herbert Meyerle, Unterfohring (DE)

Correspondence Address: Judson K. Champlin, Westman, Champlin & Kelly, Suite 1600, 900 Second Avenue South, Minneapolis, MN, 55402-3319, US

(21) Appl. No.: 10/726,260

(22) Filed: Dec. 2, 2003

Related U.S. Application Data
(63) Continuation-in-part of application No. 10/705,021, filed on Nov. 11, 2003.

(30) Foreign Application Priority Data
May 9, 2003 (DE) 103 20 873.9

(51) Int. Cl. E05B 15/16; E05B 63/00

(52) U.S. Cl. 70/422

(57) ABSTRACT

The present invention is directed to a lock, a transponder, a door lock system and method for securing a door using the devices of the present invention. In particular, the present invention relates to a keyless electronic door lock system having an access control means which is located within the cylinder body of the lock.

The present invention is directed to a lock, a transponder, a door lock system and method for securing a door using the devices of the present invention. In particular, the present invention relates to a keyless electronic door lock system having an access control means which is located within the cylinder body of the lock.

### BACKGROUND OF THE INVENTION

Although key-operated locking mechanical systems may provide adequate protection in most situations, there are some drawbacks associated with their use. Firstly, keys for the most part can be easily copied and distributed to unauthorised users. Also, if the key is ever lost or stolen, it might be necessary to replace the whole lock cylinder in order to assure that an unauthorised user does not gain access. This can be a significant disadvantage in some cases. For example, it could be costly and rather inconvenient for a business location having many employees to replace a lock cylinder each time an employee loses his key.

As an alternative to conventional key-operated mechanical locking systems, locking arrangements were designed which utilize electronic access control means for keyless entry. U.S. Pat. No. 5,447,047 discloses a keyless entry deadbolt locking system wherein an electronic access control means in the form of a decoding means is located next to the knob on the outside of the door. When the decoding means is decoded by an authorized user, a coil is energized such that a rod is moved rightward and the extensions of the rod are caused to engage with grooves of a disc whereby a shaft can be rotated and the door can be opened. Although the deadbolt offers security against prying, one of the disadvantages of this locking system is that the electronic access control means can be accessed from the outside and thus can be tampered with.

German Patent 198 51 308, the contents of which are incorporated herein by reference, describes a locking system for a door wherein the access control means is located within a knob on the inside of the door. The electronic access control means comprises a wireless data signal receiver which receives signals transmitted from a remote transmitter operated by a user. Once an authorised signal is recognized by the access control means, a solenoid is activated to control a coupling element which in turn allows the lock to be moved in a locked or unlocked position using a knob on the outside of the door. Since the remote transmitter transmits data signals using an alternating magnetic field, data signals can be transmitted with acceptable reception quality through even highly secure metal laminated doors. This allows the access control means to be placed on the inside of the door where it would be protected against tampering from the outside. However, this is only advantageous with locking cylinder standards which consist of a single element that goes through the whole door. The U.S. standard cylinder is a single cylinder. So the electronics in the knob are on the outside and can easily be manipulated. If the access control means are located on the inside of the door, an expensive through connection is necessary, which is dependent on the type of door and lock and which is difficult to install furthermore.

U.S. Pat. No. 5,531,086 discloses a keyless entry deadbolt lock arrangement for a door, wherein the access control means is located within the door. The deadbolt lock arrangement can be opened manually by inserting a key or operating a switch, or opened remotely by using a RF (radio frequency) remote controller to activate an actuator that places the lock in a locked or unlocked position. Since reception of the wireless signal by the access control means located within the door can pose a problem depending on the type of door, the top portion of the housing containing the locking cylinder is provided with openings in order to permit better reception of the signal transmitted by the remote transmitter.

There is a still a need for improved locks, transponders, door lock systems having a lock and transponder and methods for securing a door.

### SUMMARY OF THE INVENTION

Accordingly, an object of the present invention is to provide improved locks, transponders, door lock systems having a lock and transponder and methods for electronically securing a door which are easy to install, can easily be retrofitted and/or overcome the aforementioned disadvantages of the prior art.

This object is achieved with the features of the claims. The present invention is directed to a lock as recited in claims 1 to 11, a transponder as recited in claims 12 and 13, a door lock system as recited in claim 14 and a method for securing a lock for a door as recited in claim 15.

### BRIEF DESCRIPTION OF THE FIGURES

Preferred embodiments of the present invention will be further described by the following description and drawings:

FIG. 1 is a perspective view of an embodiment of the lock of the present invention.

FIG. 2 is a rear view of the embodiment shown in FIG. 1.

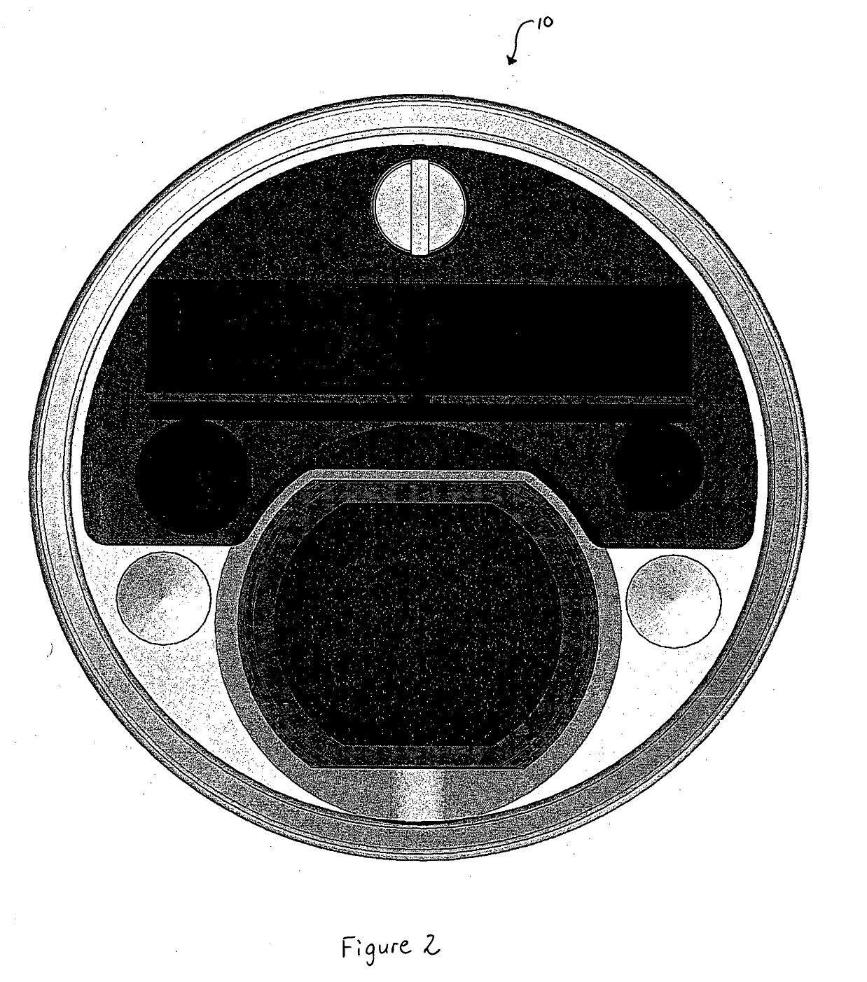

FIG. 3 is a rear prospective view of the embodiment shown in FIG. 1.

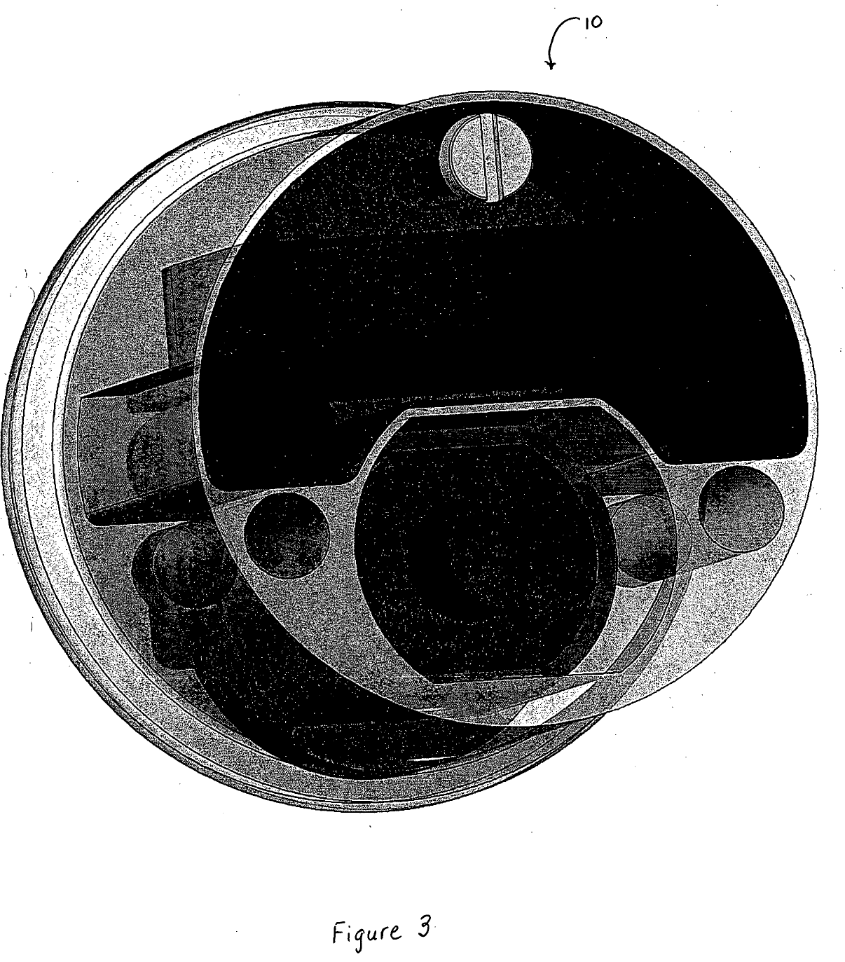

FIG. 4 is a side perspective view from the rear of the embodiment shown in FIG. 1.

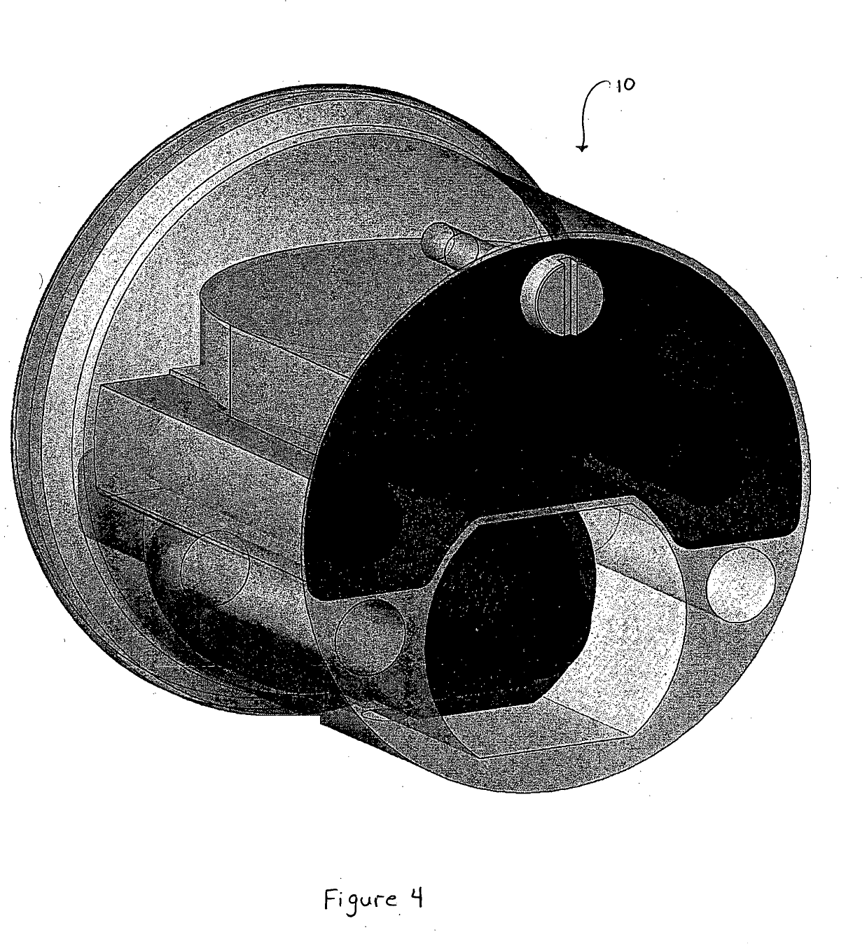

FIG. 5 shows partial side views of an embodiment of an engagement means used in the lock of the present invention.

### DESCRIPTION OF PREFERRED EMBODIMENTS

As can be seen by reference to the drawings, the lock of the present invention is designated generally by the reference number 10. The lock 10 comprises essentially a lock body 12, a knob 14, a deactivation member and an access control means 20, wherein the access control means 20 is located within the lock body 12. Since the access control means 20 is placed within the lock body 12, it is generally protected against tampering or direct access from either the inside or the outside.

The lock body 12 is generally cylindrical in shape. Moreover, the lock body 12 is adapted and sized to be fitted or introduced into a door. Preferably, the lock 10 is sized and shaped to be conveniently installed in a standard lock door hole, preferably according to U.S. standards.

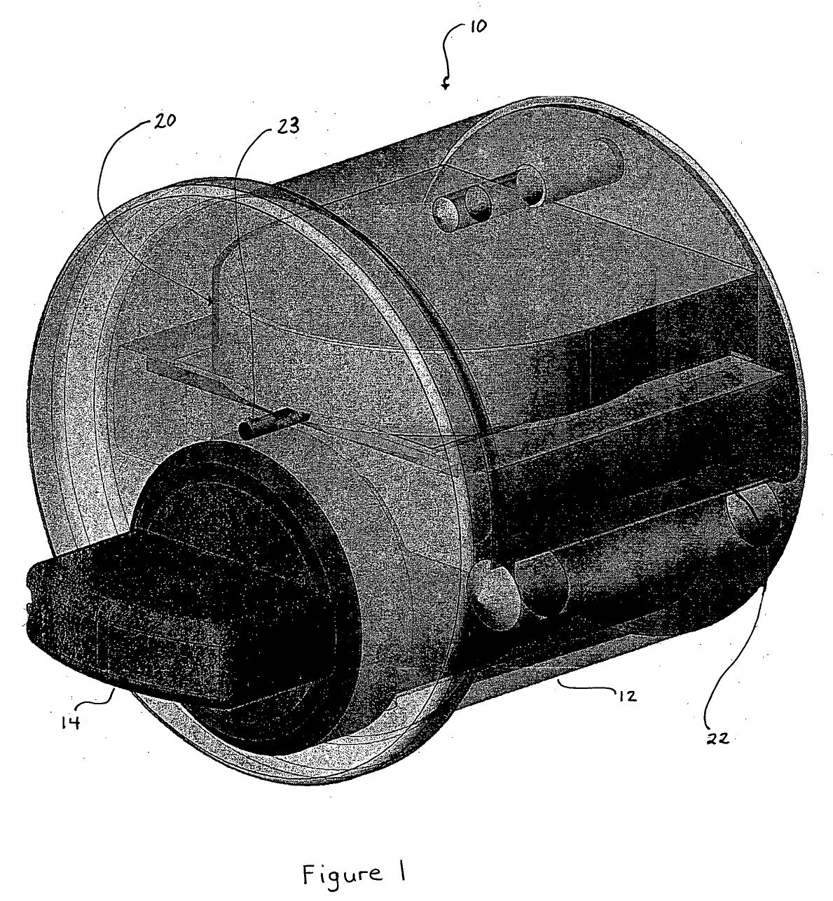

The knob 14 of the lock 10 can be used to open the door from the outside. Preferably, the lock 10 is positioned such that the knob 14 is able to be turned from the outside. The knob 14 can be in any suitable shape or form. For example, the knob 14 can be a turn button as shown in FIG. 1.

The deactivation member is provided in order to deactivate the knob 14 so that opening of the door using the knob 14 can be blocked or disabled. When actuated, the deactivation member may disable the knob 14 such that idle movement of the knob is possible. By idle movement of the knob 14, the knob 14 can be turned in any direction; however, turning of the knob 14 does not enable the user to open the door from the outside. Conversely, the deactivation member may disable the knob 14 such that idle movement or turning of the knob 14 is blocked completely.

The lock of the present invention provides keyless entry to an authorised user. The access control means 20 enables an authorized user to remotely activate the lock 10 into a locked or unlocked position using a wireless data signal exchanged with the user's remote transponder. The access control means 20 determines, based on data contained in the wireless signal, whether the user is authorized for entry. When a signal is received from an authorized user, the access control means enables the knob 14 thereby making it possible for the user to open the door from the outside.

Additionally, there can be a signalling means 23 to communicate the user operation states like a battery warning. Preferably, a light emitting diode or a piezo buzzer can be used.

The access control means 20 comprises electronic and mechanical elements. In particular, the access control means comprises a means 22 for exchanging a wireless data signal with a remote device and a verification means for verifying whether or not the wireless data signal identifies an authorized device.

Preferably, the sending/receiving means 22 of the access control means 20 is a ferrit bar antenna for exchanging signals using an alternating magnetic field from a remote transponder.

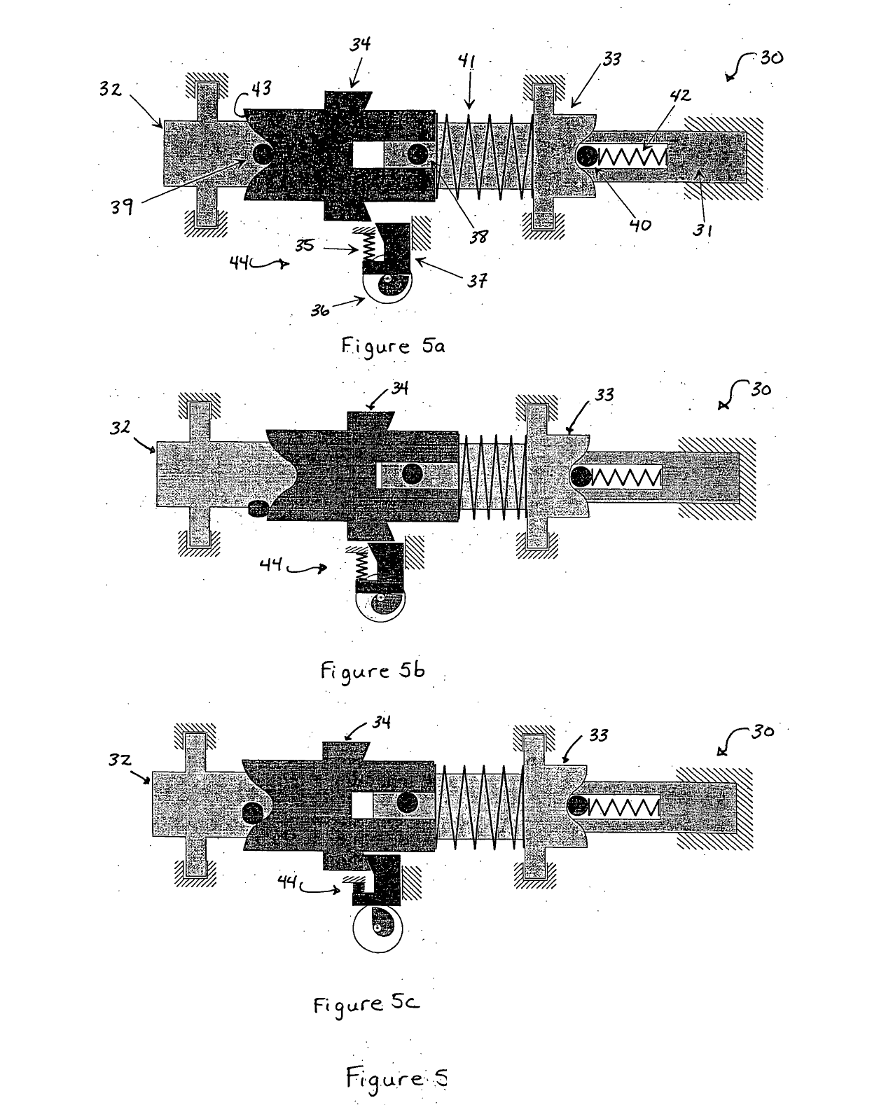

The lock 10 of the present invention preferably comprises an engagement means 30 for placing the lock or allowing the lock to be placed using the knob 14 into a locked or unlocked position. The engagement means 30 is connected to and actuated by the access control means 20. In a preferred embodiment of the invention, the engagement means 30 is so designed that it provides secure coupling and, at the same time, requires minimal energy for the shifting of the coupling. Referring to the preferred embodiment shown in FIG. 5, the engagement means 30 has preferably a drive mechanism 32 and a take-off mechanism 33, wherein the drive mechanism 32 and the take-off mechanism 33 are coupled via at least one coupling element 34 in such a manner that in a decoupled state a movement of the drive mechanism 32 causes a movement of the coupling element 34, wherein the movement of the coupling element 34 is not sufficient for transmitting a movement of the drive mechanism 32 in the direction of the take-off mechanism 33. In other words, transmission of movement is allowed in the coupled state but not in the decoupled state.

The engagement means 30 also comprises a guide 31, spring 42 connected to the guide 31, and slide elements 38, 39 and 40. Preferably, the engagement means 30 has at least one first slide surface 43 wherein the radius and/or gradient of the at least one first slide surface 43 vary along its length in order to cause a defined transmission of a movement and/or force or moment when the first slide element 39 slides along and/or contacts the first slide surface 43. Further, the engagement means comprises a coupling spring 41 being arranged between the coupling element 34 and the take-off mechanism 33, wherein it pre-stresses the coupling element 34 with respect to the drive mechanism 32 and/or take-off mechanism 33. The coupling spring 41 preferably presses the coupling element 34 or the at least one first slide surface 43 against at least one first slide element 39.

For initiating the engagement means 30 into a coupled or decoupled state, the engagement means 30 preferably comprises a coupling mechanism 44 having an actuator 36, a coupling locking element 37 and a storage device or resistor, e.g. a coupling locking spring 35. The coupling mechanism 44 is preferably configured or arranged such that the coupling locking element 37 can move essentially into two positions. In one position, the coupling locking element 37 causes a decoupled state of the engagement means 30 as shown in FIG. 5a and FIG. 5b. In the other position, the coupling locking element 37 causes a coupled state of the engagement means 30 as shown in FIG. 5c. Thus, the coupling mechanism 44 can cause a coupling and a decoupling of the drive mechanism 32 and the take-off mechanism 33 via the coupling element 34. Here, the respective state depends on the position of the coupling mechanism 44 which in turn is activated by the access control means 20. For example, when the engagement means 30 is in a coupled state, the lock can be moved from a locked position to an unlocked position using the knob 14 on the outside provided the knob 14 is enabled. The engagement means is further described in co-pending German patent application no. 103 20 873.9, the contents of which are incorporated herein by reference.

The lock 10 of the present invention also comprises a power source or means for connecting to a power source. Preferably, the lock 10 comprises a battery for energizing the access control means 20, for example, when receiving a signal from a transponder or remote transmitter.

Preferably, the lock 10 of the present invention has protection means for protecting the lock against drilling or tampering. For example, the protection means can be placed around the outside surface of the lock in order to provide additional protection against drilling from the outside. Further, the lock body 12 can be made of hard material or metal such that drilling through the lock body is prevented.

The present invention is also directed to a transponder which is adapted to communicate with a door lock. In this context, transponder stands for any portable device that contains data for authorization and that is able to communicate wirelessly.

The transponder of the present invention comprises means for exchanging a wireless data signal with the access control means of a door lock and optional means for detecting biometric information of a user. Preferably, the means for transmitting/receiving is using an alternating magnetic field.

The means for detecting biometric information of a user determines whether the user is authorized or not. With the detection means of the transponder, transmission of a data signal to the access control means of a lock can be enabled or disabled depending on the biometric information detected. The means for detecting biometric information can be, for example, a biometric finger print reader.

The present invention is also directed to a door lock system comprising a lock and transponder according to the present invention. In particular, the door lock system of the present invention comprises a lock having a lock body, a knob being able to be actuated from the outside of the door in order to open the door from the outside a deactivation member, a deactivation member which is able to deactivate the knob so that it cannot be actuated in order to open the door from the outside, and an access control means which in response to a data signal from an authorized user permits opening of the door by making it possible for the user to actuate the knob from the outside of the door in order to open it, wherein the access control means comprising electronic and mechanical elements is located within the cylindrical lock body; and a transponder having means for wireless exchanging data with the access control means of the lock.

In another aspect, the present invention is directed to a method for securing a lock for a door comprising: providing a lock body 12 being of generally cylindrical shape and being able to be introduced into a door; providing a knob 14 for the outside of the door to be locked, the knob 14 being able to be actuated from the outside of the door in order to open the door from the outside; providing a deactivation member which is able to deactivate the knob 14 so that it cannot be actuated in order to open the door from the outside, providing an access control means 20 which in response to a transponder signal of an authorized user permits opening of the door by making it possible for the user to actuate the knob 14 from the outside of the door; and providing the access control means 20 within the cylindrical lock body 12, the access control means 20 comprising electronic and mechanical elements.

The present invention is not limited to the specific illustrated embodiments. Moreover, the present invention is realized by the features of the claims and any obvious modifications thereof.

What is claimed:

1. Lock for a door to be locked with the following features:
(a) a locking cylinder body being able to be introduced into a door;
(b) a knob for the outside of the door to be locked, the knob being able to be actuated from the outside of the door in order to open the door from the outside;
(c) a deactivation member which is able to deactivate the knob so that opening of the door using the knob is not possible, the deactivation member being able to be electronically actuated;
(d) an access control means which in response to an authorized transponder signal permits opening of the door by making it possible for the user to actuate the knob from the outside of the door in order to open it;
(e) wherein the access control means comprising electronic and mechanical elements is located within the locking cylinder body.

2. Lock according to claim 1, the lock body is adapted and sized to be introduced into a door according to U.S. standards or European standards.

3. Lock according to claim 1, wherein the deactivation member is adapted to deactivate the knob such that idle movement of the knob is possible.

4. Lock according to claim 1, wherein the deactivation member is adapted to deactivate the knob such that movement of the knob is blocked.

5. Lock according to claim 1, wherein the access control means comprises means for exchanging a wireless signal with a transponder and a verification means for verifying whether or not the transponder sis authorized.

6. Lock according to claim 1, further comprising a battery energizing the access control means upon response of a request signal from a transponder.

7. Lock according to claim 1, wherein the access control means comprises a ferrit bar antenna which is also located within the cylindrical lock body.

8. Lock according to claim 1, wherein the access control means is adapted to communicate with a transponder by means of an alternating magnetic field.

9. Lock according to claim 1, further comprising protection means for protecting against drilling or tampering with the lock.

10. Lock according to claim 1, further comprising an engagement means for transmitting a movement as well as corresponding forces and/or moments, the engagement means having a drive mechanism and a take-off mechanism, wherein the drive mechanism and the take-off mechanism are coupled via at least one coupling element in such a manner that in a decoupled state a movement of the drive mechanism causes a movement of the coupling element, wherein the movement of the coupling element is not sufficient for transmitting a movement of the drive mechanism to the take-off mechanism so that transmission of movement is allowed in the coupled state but not in the decoupled state.

11. Lock according to claim 10, wherein the drive mechanism and take off mechanism are coupled via the coupling element in such a manner that in the decoupled state a rotational movement of the drive mechanism causes an essentially axial and/or radial movement of the coupling element and that in a coupled state a rotational movement of the drive mechanism essentially causes a rotational movement of the take-off mechanism.

12. Transponder for a door lock having an access control means comprising:
means for exchanging a wireless data signal with the access control means of the door lock; and
means for detecting biometric information of a user, wherein transmission of the data signal to the access control means of the lock is enabled or disabled depending on the biometric information detected.

13. Transponder according to claim 12, wherein the biometric information is a fingerprint.

14. Door lock system comprising:
a lock having a lock body, a knob being able to be actuated from the outside of the door in order to open the door from the outside a deactivation member, which is able to deactivate the knob so that it cannot be actuated in order to open the door from the outside and an access control means which in response to a data signal from an authorized user permits opening of the door by making it possible for the user to actuate the knob from the outside of the door in order to open it, wherein the access control means comprising electronic and mechanical elements is located within the cylindrical lock body; and
a transponder having means for exchanging a wireless data signal with the access control means of the lock.

15. Method for securing a lock for a door comprising:
providing a lock body being of generally cylindrical shape and being able to be introduced into a door;
providing a knob for the outside of the door to be locked, the knob being able to be actuated from the outside of the door in order to open the door from the outside;
providing a deactivation member which is able to deactivate the knob so that it cannot be actuated in order to open the door from the outside;
providing an access control means which in response to a signal of an authorized transponder permits opening of the door by making it possible for the user to actuate the knob from the outside of the door in order to open it; and
providing the access control means within the cylindrical lock body, the access control means comprising electronic and mechanical elements.
